(19) United States
(12) Patent Application Publication
(10) Pub. No.: US 2025/0305452 A1
(43) Pub. Date: Oct. 2, 2025

(54) System and Method of Air-Augmented Gas turbine Turbojet Engines

(71) Applicant: Samuel ATTAH, Cape Coral, FL (US)

(72) Inventor: Samuel ATTAH, Cape Coral, FL (US)

(21) Appl. No.: 18/617,983

(22) Filed: Mar. 27, 2024

(51) Int. Cl. F02K 3/08; F02K 3/06

(52) U.S. Cl. CPC F02C 7/08; F02C 3/14; F02C 3/32; F02K 3/08; F05D 2260/221; F05D 2260/22141

(57) ABSTRACT

A system of an air-augmented gas turbine engine is provided comprising a gas turbine engine drawing air into an increasingly narrow and elongated compression chamber, the action compressing drawn-in air. The system also forces the compressed air into and through a narrowed section of the compression chamber before the air reaching a combustion chamber, the section running alongside a lengthwise exterior surface of the combustion chamber, positioning of the section causing the compressed air to receive increased heating based on proximity of the section to the combustion chamber. The system ignites in the compression chamber a mixture of the heated compressed air and injected fuel, causing increase in temperature and velocity of the mixture. The system also directs the superheated mixture from the combustion chamber through a combustion nozzle and into an entrained state with a larger volume of cooler air, resulting in increased power and efficiency of the engine.

### CROSS REFERENCE TO RELATED APPLICATIONS

None

### FIELD OF THE DISCLOSURE

The present disclosure is in the field of gas turbine engines. More particularly, the present disclosure provides systems and methods of a gas turbine engine featuring a compression chamber whose shape and positioning allows it to capture radiated and otherwise wasted heat from the engine's combustion chamber and further for resultingly superheated gas expelled from the combustion chamber to entrain with cooler air entering via a bypass duct, two novel features that provide added power and efficiency to the engine.

### BACKGROUND

Gas turbine engines of the prior art typically have compression chambers that extend in a straight line from air intake and compressor blades into the body of the engine and to the combustion chamber. FIG. 1 illustrates a gas turbine engine of the prior art. As the arrows in FIG. 1 show, air moves from air inlet in a straight line through compression to combustion chambers on to turbine and exhaust.

Conventional gas turbine engines of the prior art are subject to the Brayton cycle, also known as the Joule cycle, a thermodynamic cycle that describes the operation of some engines that have air or some other gas as their working fluid. The air passing through the compression portion of the engine does not receive any additional heating in conventional gas turbine engines provided by the prior art. This is a standard structure of the prior art for gas turbine engines used in many applications.

### BRIEF DESCRIPTION OF THE DRAWINGS

FIG. 1 is a diagram of a gas turbine engine of the prior art.

FIG. 2 is a diagram of an air-augmented gas turbine turbojet engine according to an embodiment of the present disclosure.

FIG. 3 is a diagram of an air-augmented gas turbine turbojet engine according to an embodiment of the present disclosure.

### DETAILED DESCRIPTION

Systems and methods described herein provide a gas turbine engine that recovers heat from its combustion chambers to save fuel. The engine then entrains expelled superheated gas from its combustion chamber with cooler air to boost power and efficiency of the engine.

The compression chamber provided herein is not straight as with much of the prior art and instead bends to run alongside the combustion chambers to capture heat from the combustion chamber before air traveling in the compression chamber is forced into the combustion chamber. This structure raises the temperature of compressed air before it reaches the combustion chamber.

Thereafter the superheated gas expelled from the combustor draws in relatively cooler secondary air entering via bypass ducts. This cooler mixture is what then drives the turbines. Less fuel is required to superheat the gas and additional power and efficiency are realized from the combination of the superheated gas with the cooler air arriving via the bypass ducts. The recuperation of wasted heat prior to combustion and the entrainment of cooling secondary airflow after combustion are two novel features of the present disclosure.

For gas turbine engines of the prior art, a bottleneck is heat management, both for the structural integrity of the engine and its thermal efficiency. The hotter and engine is made, the more efficient it will be. But an engine cannot be made so hot that components begin melting. The structure provided herein mitigates this limitation by channeling air from the compressors in a novel manner that allows relatively cooler compressed air to recover excess heat radiated by the combustion chamber.

Preheated air does not need as much fuel to raise its temperature within the combustion chamber. This boosts efficiency and may reduce costs. The combustion process can be made as hot as possible, and the superheated combusted air, once expelled from the combustion chamber, is then used to draw in and entrain with cooler atmospheric air via the Coanda effect. This cooler mixture of high-velocity air is what then drives the turbines. The turbines drive the compressors and the cycle is completed.

The heat of the air traveling through the compression chamber is boosted before it reaches the combustion chamber. This reduces the need for fuel in the combustion chamber to produce a superheated gas. The process allows the gas created in the combustion chamber to be superheated with less fuel before the gas is expelled via the combustion chamber's nozzle and thereafter entrains with cooler air from bypass ducts.

After the superheated gas is expelled from the combustion chamber, it travels along a series of small flat panels positioned atop a curved surface. There the gas entrains with cooler air entering the engine via a bypass duct based on the aforementioned Coanda effect.

Many prior art configurations of gas turbine engines feature compression chambers that narrow quickly after receiving air from the compressor and proceed directly in a straight line to the combustion chamber. The compression chamber provided herein by contrast does not feature such a structure and instead bends backward and runs alongside the combustion chamber. This positioning allows heat radiated by the combustion chamber that would otherwise be wasted to be used to heat air traveling through the compression chamber shortly before it reaches and is forced into the combustion chamber.

The positioning of the compression chamber proximate the combustion chamber results in air entering the combustion chamber to be significantly hotter than it would be without this structure. Further, the superheated gas expelled via a nozzle of the combustion chamber running along the curved surface and entraining with cooler air entering via bypass ducts provides extra power and thrust for the engine.

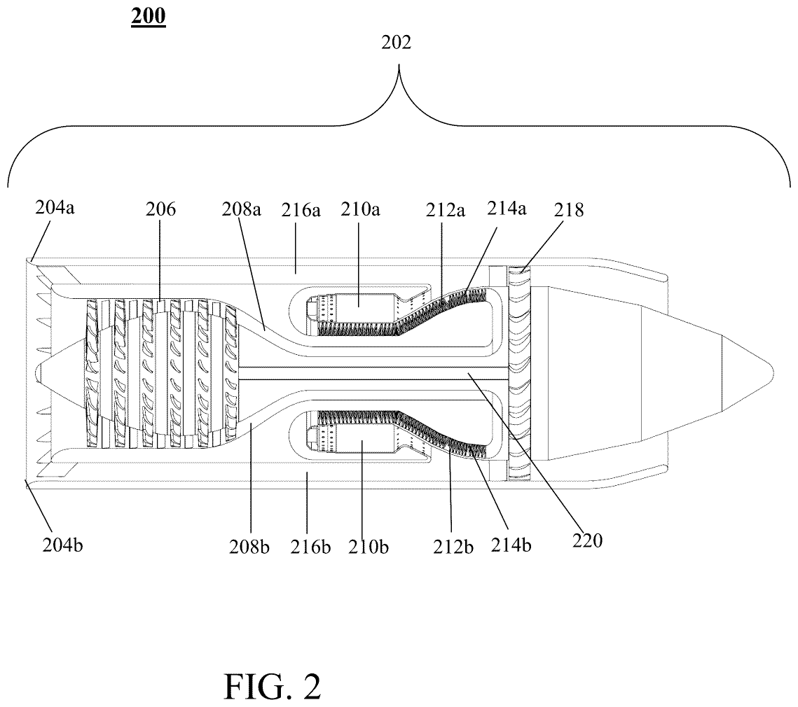

Turning again to the figures, FIG. 2 is a diagram of an air-augmented gas turbine turbojet engine according to an embodiment of the present disclosure. FIG. 2 depicts components of a system 200 comprising an engine 202, air intakes 204a-b, compressor blades 206, a compression chamber 208a-b, a combustion chamber 210a-b, flat plates 212a-b, curved surfaces 214a-b, bypass ducts 216a-b, a turbine 218, and a shaft 220.

FIG. 2 depicts a structure of the system 200 in which there are a pair or two each of air intakes 204a-b, compression chambers 208a-b, combustion chambers 210a-b, flat plates 212a-b, curved surfaces 214a-b, and bypass ducts 216, hence the use of the letters “a” and “b” to differentiate between, for example, air intake 204a and air intake 204b on the opposite sides of the engine 202.

For purposes of this discussion, air intake 204a and air intake 204b are the same component and discussion of the “a” version of a component is assumed to apply to the “b” version of the component unless otherwise explicitly stated. Further, it is not a requirement of systems and methods provided herein to include the pair or two each of components as described above. A single set of components, for example just the “a” version or the “b” version is sufficient to support the teachings provided herein.

Air intake 204 draws air into the engine 202 where compressor blades 206 force the drawn-in air into the compression chamber 208a-b. As is apparent from FIG. 2, the compression chamber 208a-b has an unusual shape and positioning. The compression chamber 208a-b becomes increasingly elongated and narrow and extends past the position of the combustion chamber 210a-b and then bends backward toward the combustion chamber 210a-b.

As illustrated, the compression chamber 208a-b then runs alongside a lengthwise surface of the combustion chamber 210a-b and receives radiated heat therefrom. The temperature in the air passing through the compression chamber 208a-b is as a result increased shortly before the air is driven into the combustion chamber 210a-b. Once in the combustion chamber 210a-b, the heated air is combined with fuel and ignited to create a superheated gas which is then expelled through a nozzle of the combustion chamber 210a-b.

After expulsion via the nozzle, the superheated gas passes along a series of small flat plates 212a-b placed atop the curved surface 214a-b. The superheated gas adheres to the flat plates 212a-b along the curved surface 214a-b via at least the Coanda effect and/or the Bernoulli principle. The gas combines with cooler air entering the engine through bypass ducts 216a-b in an entrainment process and the combined air then passes through the turbine 218. The turbine 218 turns the shaft 220 which turns the compressor blades 206, completing the cycle.

The at least two novel features provided herein of the heating of the air before it reaches the combustion chamber 210a-b and the movement of the superheated gas over the curved surface 214a-b and entrainment with cooler air boost power and efficiency of the engine 200 and reduce fuel consumption, providing economic benefits.

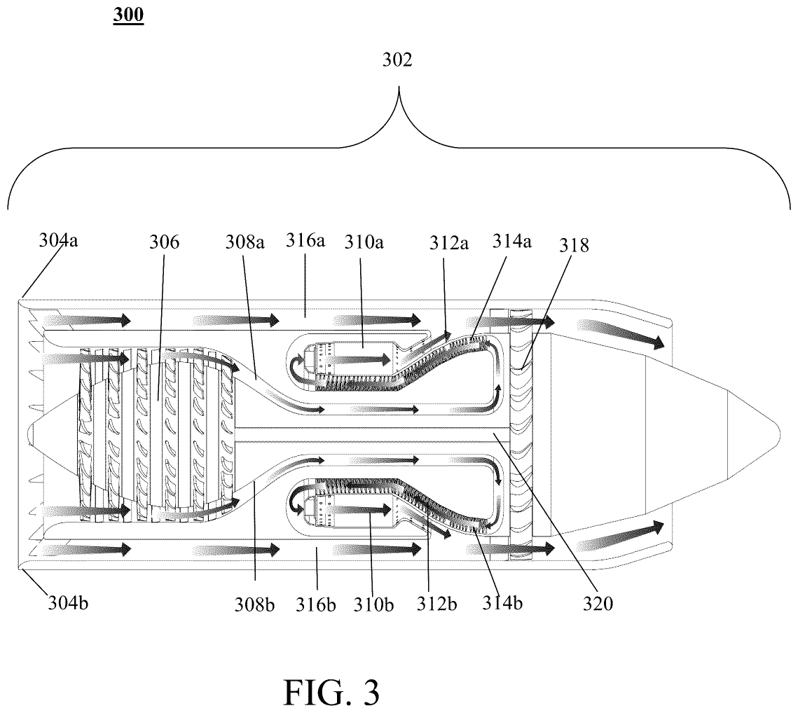

FIG. 3 is a diagram of an air-augmented gas turbine turbojet engine according to an embodiment of the present disclosure. FIG. 3 is similar to FIG. 2 and provides arrows to show the flow of air through a system 300.

Components of the system 300 are indexed to components of the system 200. Components of the system 300 comprise an engine 302, air intakes 304a-b, compressor blades 306, a compression chamber 308a-b, a combustion chamber 310a-b, flat plates 312a-b, curved surfaces 314a-b, bypass ducts 316a-b, a turbine 318, and a shaft 320.

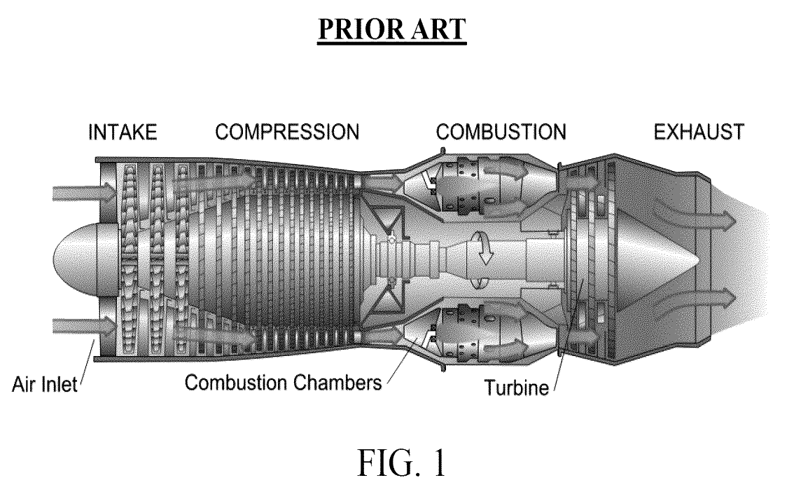

FIG. 3 depicts air flowing into the engine 302 through the air intakes 304a-b, past the compressor blades 306 and into the compression chamber 308a-b. As is evident in FIG. 3 as well as in FIG. 2, the compression chambers 308a-b do not proceed in a straight or nearly straight line to the combustion chambers 310a-b as is the case with the prior art and depicted in FIG. 1.

Instead, systems and methods provided herein teach that the compression chambers 308a-b bend backwards such that the compression chambers 308a-b run alongside extended surfaces of the combustion chambers 310a-b shorty before air from the compression chambers 308a-b is forced into the combustion chambers 310a-b. This structure allows heat radiated by the combustion chambers 310a-b to be absorbed by the compression chambers 308a-b as described in detail above.

The arrows in FIG. 3 also show how cooler air enters the engine 302 via the bypass ducts 316a-b. The cooler air is entrained with superheated gas traveling along the flat plates 312a-b atop curved surfaces 314a-b, adding power to the engine 302 before the entrained mixture of superheated gas and cooler air is driven past the turbine 318, driving the turbine 318 and exiting the engine 302 as thrust to drive an aircraft or other vehicle using the engine 302 to drive acceleration and movement.

In an embodiment, a system of an air-augmented gas turbine engine is provided comprising a gas turbine engine that draws air into an increasingly narrow and elongated compression chamber, the action compressing the drawn-in air. The system also forces the compressed air into and through a narrowed section of the compression chamber prior to the air reaching a combustion chamber, the section running alongside a lengthwise exterior surface of the combustion chamber, positioning of the section causing the compressed air to receive increased heating based on proximity of the section to the combustion chamber. The system also ignites in the compression chamber a mixture of the heated compressed air and injected fuel, causing a rapid increase in temperature and velocity of the mixture. The system also directs the superheated mixture from the combustion chamber through a combustion nozzle and into an entrained state with a larger volume of cooler air, resulting in increased power and efficiency of the engine.

The system drawing air into the increasingly narrow and elongated compression chamber increases temperature and pressure of the drawn-in air. The mixture, upon exiting the combustion chamber by a nozzle, moves over a series of flat angled segments.

The mixture moving over the series of flat angled segments, creates a curve, or a smooth and curved surface, causing the mixture to remain attached to a curved surface hosting the segments. The mixture remaining attached to the curved surface reduces static pressure, increases velocity of the mixture, and leads to an entrainment state with a larger volume of cooler air.

The mixture remaining attached to the curved surface and leading to the entrainment state with the cooler air is based on the Coanda effect and/or the Bernoulli principle. The cooler air is drawn into the engine via a bypass duct.

Design of the engine promotes combustion of larger volume of compressed air at or close to stoichiometric ratios. Design of the engine promotes the process to be made as hot as possible without damaging or melting turbine blades and combustion chamber.

Design of the engine improves power and efficiency without consuming compressor discharge air, without the use of afterburners, without heat-resistant coatings, and without super alloys. Design of the engine improves power and efficiency with increased speed of a vehicle using the engine as the vehicle moves through a fluid comprising at least air due to ram-air effect.

In another embodiment, a system for increasing power and efficiency of gas turbine engines is provided. The system comprises air intake blades positioned proximate a forward area of a gas turbine engine that draw air into the engine and force the drawn-in air into an increasingly narrow compression chamber. The system also comprises a combustion chamber in the gas turbine engine. The compression chamber has an elongated structure that is partially positioned to extend alongside and proximate the combustion chamber and a compression nozzle. The increasingly narrow compression chamber receives, based on the positioning, heat radiated by the combustion chamber, increases temperature of the air passing within based on the received radiated heat, and transports the air with the increased temperature into the combustion chamber.

Design of the engine promotes combustion of larger volume of compressed air at or close to stoichiometric ratios. Increased temperature of the air promotes reduced need for fuel expended in the combustion chamber. The compression chamber is proximate the combustion chamber at an area where a section of the compression chamber runs alongside a lengthwise exterior surface of the combustion chamber.

In yet another embodiment, a method for improving performance of gas turbine engines is provided. The method comprises a gas turbine engine receiving superheated gas released from a nozzle of a combustion chamber positioned inside the engine. The method also comprises the engine passing the gas along a series of flat, angled segments or smooth curved surface beyond the nozzle and prior to reaching a turbine inside the engine, the gas adhering to the curved surface and resulting in a reduced static pressure and an increased velocity of the gas. The method also comprises the engine entraining the gas with a larger volume of cooler air. The method also comprises the engine driving the entrained gas and cooler air to the turbine.

The gas adhering to the curved surface and entraining with the cooler air is due at least in part to the Coanda effect and/or the Bernoulli principle. The gas adhering to the curved surface resulting in a reduced static pressure and an increased velocity of the gas.

The cooler air is drawn into the engine via a bypass duct. The engine driving the entrained gas and cooler air to the turbine results in the turbine turning compressor blades via a shaft.

In some embodiments, a recuperator device (not shown in the figures) providing heat exchange may be positioned in the areas where the compression chambers 308a-b are proximate the combustion chambers 310a-b, further enhancing heat transfer as described above.

What is claimed is:

1. A system of an air-augmented gas turbine engine, comprising:
a gas turbine engine that:
draws air into an increasingly narrow and elongated compression chamber, the action compressing the drawn-in air,
forces the compressed air into and through a narrowed section of the compression chamber prior to the air reaching a combustion chamber, the section running alongside a lengthwise exterior surface of the combustion chamber, positioning of the section causing the compressed air to receive increased heating based on proximity of the section to the combustion chamber,
ignites in the compression chamber a mixture of the heated compressed air and injected fuel, causing a rapid increase in temperature and velocity of the mixture, and
directs the superheated mixture from the combustion chamber through a combustion nozzle and into an entrained state with a larger volume of cooler air, resulting in increased power and efficiency of the engine.

2. The system of claim 1, wherein the system drawing air into the increasingly narrow and elongated compression chamber increases temperature and pressure of the drawn-in air.

3. The system of claim 1, wherein the mixture, upon exiting the combustion chamber by a nozzle, moves over a series of flat angled segments.

4. The system of claim 3, wherein the mixture moving over the series of flat angled segments, creates a curve, or a smooth and curved surface, causing the mixture to remain attached to a curved surface hosting the segments.

5. The system of claim 4, wherein the mixture remaining attached to the curved surface reduces static pressure, increases velocity of the mixture, and leads to an entrainment state with a larger volume of cooler air.

6. The system of claim 5, wherein the mixture remaining attached to the curved surface and leading to the entrainment state with the cooler air is based on the Coanda effect and/or the Bernoulli principle.

7. The system of claim 5, wherein the cooler air is drawn into the engine via a bypass duct.

8. The system of claim 1, wherein design of the engine promotes combustion of larger volume of compressed air at or close to stoichiometric ratios.

9. The system of claim 1, wherein design of the engine promotes the process to be made as hot as possible without damaging or melting turbine blades and combustion chamber.

10. The system of claim 1, wherein design of the engine improves power and efficiency without consuming compressor discharge air, without the use of afterburners, without heat-resistant coatings, and without super alloys.

11. The system of claim 1, wherein design of the engine improves power and efficiency with increased speed of a vehicle using the engine as the vehicle moves through a fluid comprising at least air due to ram-air effect.

12. A system for increasing power and efficiency of gas turbine engines, comprising:
air intake blades positioned proximate a forward area of a gas turbine engine that draw air into the engine and force the drawn-in air into an increasingly narrow compression chamber;
a combustion chamber in the gas turbine engine; and
the increasingly narrow compression chamber with an elongated structure that:
is partially positioned to extend alongside and proximate the combustion chamber and a compression nozzle,
receives, based on the positioning, heat radiated by the combustion chamber,
increases temperature of the air passing within based on the received radiated heat, and
transports the air with the increased temperature into the combustion chamber.

13. The system of claim 12, wherein design of the engine promotes combustion of larger volume of compressed air at or close to stoichiometric ratios.

14. The system of claim 12, wherein increased temperature of the air promotes reduced need for fuel expended in the combustion chamber.

15. The system of claim 12, wherein the compression chamber is proximate the combustion chamber at an area where a section of the compression chamber runs alongside a lengthwise exterior surface of the combustion chamber.

16. A method for improving performance of gas turbine engines, comprising:
a gas turbine engine receiving superheated gas released from a nozzle of a combustion chamber positioned inside the engine;
the engine passing the gas along a series of flat, angled segments or smooth curved surface beyond the nozzle and prior to reaching a turbine inside the engine, the gas adhering to the curved surface and resulting in a reduced static pressure and an increased velocity of the gas;
the engine entraining the gas with a larger volume of cooler air; and
the engine driving the entrained gas and cooler air to the turbine.

17. The method of claim 16, wherein the gas adhering to the curved surface and entraining with the cooler air is due at least in part to the Coanda effect and/or the Bernoulli principle.

18. The method of claim 16, further comprising the gas adhering to the curved surface resulting in a reduced static pressure and an increased velocity of the gas.

19. The method of claim 16, wherein the cooler air is drawn into the engine via a bypass duct.

20. The method of claim 16, wherein the engine driving the entrained gas and cooler air to the turbine results in the turbine turning compressor blades via a shaft.
